(19) United States
(12) Patent Application Publication
(10) Pub. No.: US 2026/0368833 A1
(43) Pub. Date: Nov. 19, 2026

(54) DINING PROFILE GENERATION SYSTEMS AND METHODS

(71) Applicant: Scipco LLC, Boca Raton, FL (US)

(72) Inventors: Cole Rubin, Boca Raton, FL (US); Jackson Phifer, New York, NY (US)

(21) Appl. No.: 19/443,346

(22) Filed: Jan. 8, 2026

Related U.S. Application Data
(63) Continuation-in-part of application No. 19/412,478, filed on Dec. 8, 2025.
Application No. 19/412,478 is a continuation-in-part of application No. 19/208,317, filed on May 14, 2025, now Pat. No. 12,645,680.
(60) Provisional application No. 63/727,760, filed on Dec. 4, 2024.

(51) Int. Cl. G06Q 50/12

(52) U.S. Cl. CPC G06Q 50/12

(57) ABSTRACT

Systems and methods for creating a dining profile are disclosed. One embodiment includes querying a user media database, and receiving metadata associated with user media stored in the user media database based on the querying. The metadata may be analyzed to determine one or more locations that have been visited by a user associated with the user media. A match between location information in the metadata and a restaurant location included in the one or more locations may be determined. In an aspect, the restaurant location is added to a list of restaurant locations visited by the user, and a dining profile for the user is generated based on the list.

This application is a continuation-in-part of U.S. patent application Ser. No. 19/412,478, filed Dec. 8, 2025, titled “Fan Profile Generation Systems and Methods” which is incorporated by reference herein in its entirety. That application is a continuation-in-part of U.S. patent application Ser. No. 19/208,317, filed May 14, 2025, titled “Event Tracking Systems and Methods” which is incorporated by reference herein in its entirety. That application claims the priority benefit of provisional patent application No. 63/727,760 titled “Event Tracking Systems and Methods” filed on Dec. 4, 2024, the disclosure of which is incorporated by reference herein in its entirety.

### BACKGROUND

### Technical Field

The present disclosure relates to systems and methods configured to generate a comprehensive profile and understanding of a user's dining habits (also referred to herein as a “dining profile”), based on processing metadata embedded in one or more media files captured by a user mobile device when the user is at a specific restaurant or dining location.

### Background Art

Current mobile devices such as mobile phones, laptop computers, wearable devices, and tablets include image and video capturing devices such as cameras. Images and video (also referred to herein collectively as “media”, “user media”, or “media files”) captured by a camera mobile device are typically stored in a database on the mobile device (e.g., a camera roll). These media files can be further annotated with data/metadata (e.g., EXIF) that includes exposure information, date and time, image capture device information, and global positioning system (GPS)-enabled location. This data/metadata can be extracted from the images and video and used, for example, to determine when and where an image was captured.

### SUMMARY

Aspects of the invention are directed to systems and methods for generating a fan profile associated with a user, based on location metadata derived from one or more media files captured by the user when at a specific location. One method includes querying a user media database, and receiving metadata associated with user media stored in the user media database based on the querying. The method may iterate through the media metadata to create one or more clusters comprised of similar locations at which one or more media files stored in the user media database have been captured by the user, and filter out any clusters of the clusters that are less than a threshold size. For each remaining cluster, a time range may be created. All remaining clusters and associated locations within the time range may be categorized and aggregated. One aspect includes analyzing all categorized and aggregated remaining clusters to infer demographic traits associated with the user, and exporting a final fan profile associated with the user based on the analyzing.

In one aspect, location is any of a retail store, a fitness center, a sporting event location, a restaurant, a performing arts location, a hotel, a movie theater, and a transportation location.

One aspect the iterating further comprises including any location not included in a cluster within a predetermined distance of one or more existing locations in the cluster into the cluster, and merging any intersecting clusters into a single cluster.

An aspect includes creating a cluster centerpoint for each cluster by averaging latitudes and longitudes of all locations included in each cluster. For each cluster, a location from a set of locations that is closest to the centerpoint of each cluster may be identified as a cluster location associated with each cluster.

In one aspect, a Euclidian distance from the center point of each cluster to a center point of each location from the set of locations is used as a measure to determine a closeness for each location from the set of locations. In an aspect, the closeness for each location from the set of locations is used to determine the location from the set of locations that is closest to the center point of each cluster.

An aspect includes adjusting the threshold size to provide a change in a granularity associated with the filtering. In aspect, the creating a time range further comprises ordering the clustered locations from earliest to latest in terms of intraday time, filtering out a first predefined percentile of the clustered locations and a final predefined percentile of the clustered locations to obtain a truncated set of clustered locations, and defining the time range as outer temporal bounds of the truncated cluster.

In an aspect, the time range is classified into a plurality of categories, including morning, afternoon, night, and late-night. Each category definition may include a respective time duration in hours.

One aspect includes estimating an income bracket associated with the user, identifying one or more lifestyle traits associated with the user by finding dominant categories and subcategories, and generating behavioral tags using any combination of time-of-day patterns, location types, and cluster frequency.

In one aspect, each location is identified by a code such as an North American Industry Classification System (NAICS) code or a European NACE code.

Other aspects include computer systems and/or apparatuses that implement the above method.

Other aspects of the invention are directed to systems and methods for generating a restaurant/dining profile associated with a user. One aspect includes querying a user media database, and receiving metadata associated with user media stored in the user media database based on the querying. The media metadata may be analyzed to determine one or more locations that have been visited by the user associated with the user media. A match between the metadata and a restaurant location may be determined. In an aspect, the restaurant location is added to a list of restaurant locations visited by the user, and a restaurant/dining profile is generated for the user based on the list.

Other aspects include computer systems and/or apparatuses that implement the above method.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting a computer architecture of an event tracking system.

FIG. 2 is a flow diagram depicting a method to transmit a list of matched events to a user.

FIG. 3 is a block diagram depicting a computing system.

FIG. 4 is a flow diagram depicting a method to categorize a temporally closest event as a matching event.

FIGS. 5-17 are screenshots depicting user interfaces associated with the systems and methods described herein.

FIG. 18 is a block diagram depicting a computer architecture of a fan profile generation system.

FIG. 19 is a flow diagram depicting a method to generate a fan profile.

FIGS. 20A-20C are screenshots depicting a sample fan profile.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Mobile device owners oftentimes use their mobile devices to capture images and video (referred to herein as “media” or “media files”) of and/or at an event that they attend. Examples of such events include concerts, movies, theater events, sports events, recreational events (golf, fishing, etc.), and dining experiences. The images and videos captured at these events generally include embedded data such as EXIF data/metadata. This data/metadata is used by the systems and methods described herein, to generate a list of events attended by a mobile device user based on data/metadata extracted from an image database associated with the mobile device. The list of events can be provided to the user as a set of memories. The user can relive an experience of attending the events by viewing the memories. Based on the list of events, future events of potential interest to the user can be recommended to the user.

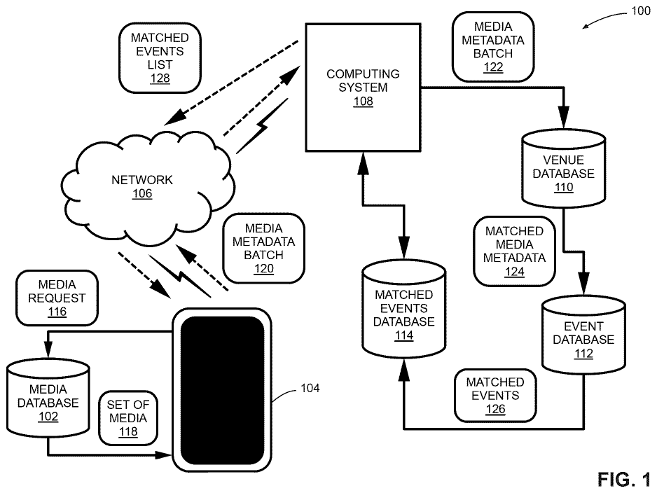

FIG. 1 is a block diagram depicting a computer architecture of an event tracking system 100. As depicted, event tracking system 100 includes media database 102, user mobile device 104, network 106, remote computing system 108, venue database 110, event database 112, and matched events database 114.

In an aspect, user mobile device 104 is configured to communicate with remote computing system 108 via network 106. Network 106 may be a public network (e.g., the Internet), or a private network. User mobile device 104 may be carried by a user to different events (e.g., concerts, movies and sports events). The user may use user mobile device 104 to capture media and generate media files comprising one or more images and/or video during an event. This media may be stored to media database 102, included in the user mobile device 104. Alternatively, media database 102 may be a database on a remote server such as a cloud server.

In one aspect, user mobile device 104 is a portable/mobile computing system/platform such as a mobile phone, a tablet, a laptop computer, and so on. The systems and methods described herein can also be implemented using a user computing device such as a desktop computer (not depicted in FIG. 1) that may be used in conjunction with or in place of user mobile device 104. As will be generally understood, the user mobile device 104 is a user computing system that includes at least one processor, a memory, and a network interface.

In an aspect, the media stored on media database 102 may also include embedded data/metadata related to exposure information, date and time, media capture device information, and GPS-enabled location. In an aspect, remote computing system 108 may be implemented as a remote server (e.g., a cloud-based computing system or a cloud-based server). Remote computing system 108 may communicate with user mobile device 104 and the user via, for example, an application software (app) running on user mobile device 104. The application software running on user mobile device 104 may be configured to communicate with computing system 108 via network 106.

In one aspect, user mobile device 104 periodically initiates a media request 116 to media database 102 (e.g., when the user opens the app running on user mobile device 104). Media database 102 (e.g., a camera roll) may respond with an output that includes a complete set of media 118 (e.g., an entire camera roll). User mobile device 104 may extract metadata from each media file from the media database 102. In an aspect, user mobile device 104 creates one or more media metadata batches from all the metadata, and transmits the metadata batches 120 to remote computing system 108, via network 106.

Separately, remote computing system 108 may generate a set of venues associated with one or more events, and a set of events. The set of venues may be stored in venue database 110. In an aspect, venue database is a PostGis database. The set of events may be stored in event database 112. Remote computing system 108 may iterate through (e.g., query) the media metadata batch 120 from user mobile device 104 as media metadata batch 122, to find a match between a location in metadata included in metadata batch 122, associated with one or more media files sourced from media database 102, and one or more venues stored on venue database 110. For each matched venue from venue database 110 (represented as matched media metadata 124), remote computing system 108 attempts to determine an event that is within a certain timeframe (e.g., +/−6 hours) of a metadata timestamp associated with a media file, by querying event database 112. In an aspect, matched media metadata 124 is within a designated radius of a venue.

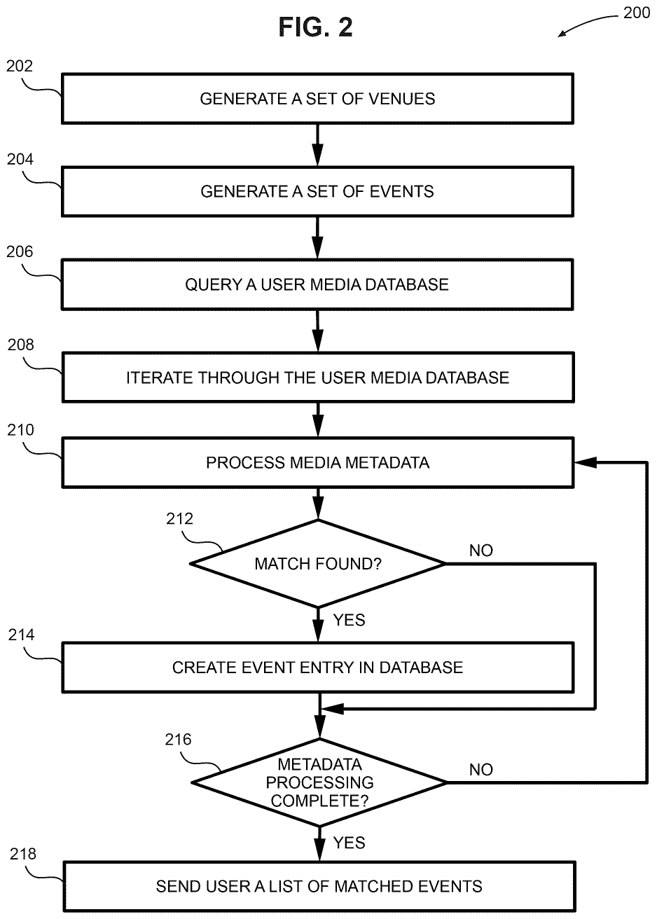

If an event is found, an event identifier is returned as a matching event (i.e., matched event(s) 126), and an entry is created and stored in matched events database 114. Once remote computing system 108 has completed processing all the metadata from the media files in media database 102, remote computing system 108 transmits a complete list of events attended (stored in matched events database 114) to user mobile device 104 as matched events list 128, via network 106. The remote computing system 108 processes media files in batches via the metadata batches 120 and 122. In one aspect, the remote computing system 108 sends a response back to the user mobile device 104 after each batch is fully processed, rather than waiting for all batches to be processed before sending a single response. The associated application software running on user mobile device 104 handles reconciliation and aggregation of these responses. The user can view this list of events attended via the associated application software, on user media device 104. FIG. 2 is a flow diagram depicting a method 200 to transmit a list of matched events to a user. In one aspect, method 200 includes generating a set of venues (202). For example, remote computing system 108 may generate a set of venues, Vₚ, where each venue v∈Vₚ contains at least the following information:
A venue identifier (ID) iᵥ
A latitude aᵥ associated with the venue
A longitude oᵥ associated with the venue
An altitude hᵥ associated with the venue
A radius rᵥ associated with the venue

In one aspect, the set of venues Vₚ is stored in venue database 110. Radius rᵥ may be measured in meters. Radius rᵥ may be used as a limiting boundary distance from an associated venue.

At 204, method 200 generates a set of events. For example, remote computing system 108 may generate a set of events, Eₚ, where each event e∈Eₚ contains (at least) the following information:
An event identifier (ID) iₑ
An ISO-8601-format date string tₑ
A venue identifier (ID) kₑ, associated with the event and separate from the venue identifier iᵥ

In an aspect, the date string tₑ is in a coordinated universal time (UTC) format. The venue identifier kₑ is used to identify a venue that an event iₑ is being held at. In one aspect, the set of events Eₚ is stored in event database 112.

In one aspect, method 200 includes an application running on user mobile device 104 being allowed full access, by the user, to media database 102 (e.g., a camera roll) (206). For example, remote computing system 108 may query the entire media database 102, including the following metadata:
A media timestamp tₘ associated with each media file
A media location, that further includes:
   A latitude aₘ
   A longitude oₘ
   An altitude hₘ

In one aspect, latitude aₘ, longitude oₘ and altitude hₘ are embedded in the media metadata based on data from an onboard GPS unit associated with user mobile device 104.

In one aspect, method 200 includes iterating the user's media database 102 (208). For example, remote computing system 108 may iterate through a camera roll associated with user mobile device 104. The camera roll may include one or more media files. Remote computing system 108 may iterate through the media files in batches of 1000 media files. In other embodiments, the batch number may be different from 1000 media files. This iteration process may include the following operations:
Media metadata, M, is sent from user mobile device 104 to remote computing system 108 (e.g., as media metadata batch 120).
   Data transferred to remote computing device 108 from user mobile device 104 may be limited to media metadata only, with no media files being transmitted from user mobile device 104 to remote computing device 108. The actual media files may remain on user mobile device 104 (i.e., and/or media database 102).
   Requests to remote computing system 108 may be sent in parallel.
   Requests may include metadata batches containing embedded media metadata (e.g. EXIF, geolocation, timestamp data).
   The client side (i.e., user mobile device 104) may transmit requests as quickly as it can process the media files stored in media database 102.

In one aspect, during 208, an application software running on user mobile device 104 extracts metadata from the media files stored in media database 102, and transmits this metadata to remote computing system 108, (e.g., as media metadata batch 120).

Method 200 may process metadata from the media files stored in media database 102 (210). For each media metadata m∈M in media metadata batch 120 received by remote computing system 108, method 200 performs the following operations at 210:
∀v∈Vₚ, find a distance (e.g., in meters) between the venue and metadata as dᵥ=H(aᵥ, oᵥ, hᵥ, aₘ, oₘ, hₘ), where H is the haversine function.
Find a closest venue to the media file, v_{c}, that does not exceed the venue's radius

vᵣ={v∈Vₚ|dᵥ≤rᵥ}

d_{c}=min{dᵣ∈Vᵣ}

v_{c}=v|dᵥ=d_{c}
If no venue is found, return nothing
Let the set of events at this venue be E_{c}={e∈E|kₑ=iᵥ_{_{c}}}
∀e∈E_{c}, find the earliest event, eₘ that is within a certain time range (e.g., 6 hours) of the metadata timestamp.

tₑ≥tₘ−6 hours

tₑ≤tₘ+6 hours

tₙ=min{tₑ∈E_{c}}

eₘ=e|tₑ=tₙ
Return eₘ as the matching event

At 212, method 200 checks to determine whether a match was found. If a match was found, method 200 creates/adds an event entry in the database (214). The entry:
Includes all relevant metadata
Includes a relation to the event that was flagged

In an aspect, the event entry is added to matched events database 114. The event then goes to 216.

On the other hand, if, at 212, no match was found, then method 200 goes directly to 216, where method 200 checks to determine whether metadata processing for all media files is complete. If metadata processing is not complete, then the method returns to 210. If the metadata processing is complete, then method 200 goes to 218, where the method sends the user a complete list of (matched) events attended by the user. The list may include:
Media, to include photos and/or video corresponding to the matched metadata
Event information, to include:
   Date
   Performers/teams
   Customized information, such as:
      Set list (if the event is a concert)
      Box score (if the event is a sports game)

In one aspect, the event matching algorithm (e.g., method 200) can also utilize the contents of the media itself to match to a specific venue or a specific event (e.g., based on media stored in media database 102). This media matching algorithm can be used independently of the metadata or in conjunction with the metadata. If the media is matched against a specific venue, the timestamp (included in the media metadata) will need to be used to find the Event at the matched venue at that specific time. If media is matched against a specific event (using specific text, performer+venue uniqueness, etc.), no media metadata will be used to determine a match. In one aspect, media metadata is used to validate the match.

The media analysis and subsequent matching is done using the following technique. An image is run through an initial segmentation layer to identify key attributes/features to be later analyzed. These attributes/features include people, text, advertisements, and key landmarks (stage, field, etc.). These key attributes/features are embedded and used to match against known key attributes/features from a curated database of performers, teams, and stadium landmarks. This process works differently for the two different types of media (i.e., an image versus a video). For an individual image, the image itself is analyzed. For a video, one frame/second is pulled to then be analyzed. All matches above a certain similarity score are included. Conflicts are resolved on the venue attribute by comparing the most common match within a venue.

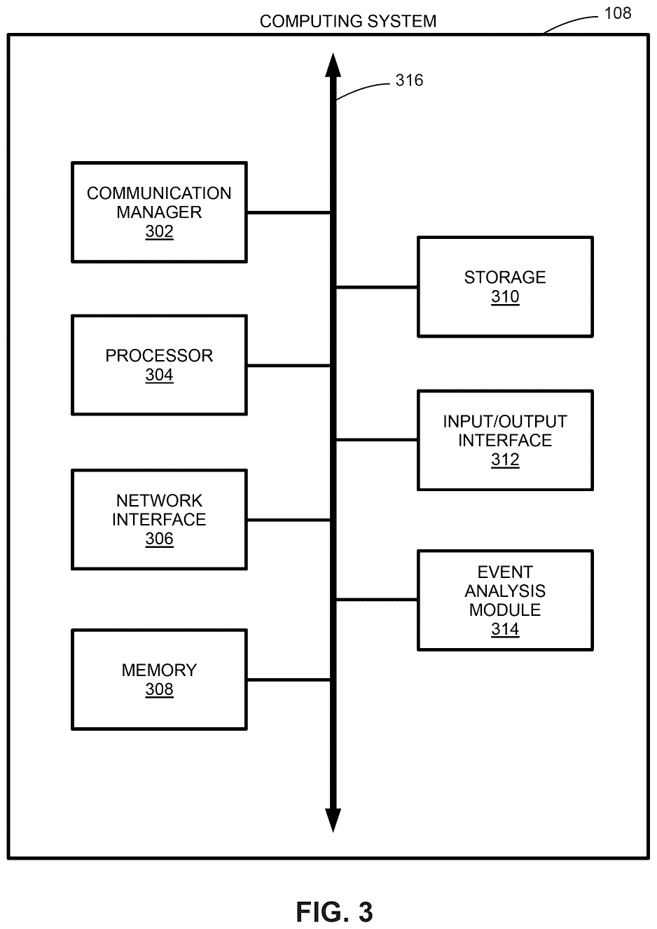

FIG. 3 is a block diagram depicting computing system 108. As depicted, computing system 108 includes communication manager 302, processor 304, network interface 306, memory 308, storage 310, input/output interface 312, event analysis module 314, and system bus 320.

In an aspect, communication manager 302 is configured to manage communication protocols and associated communication with external peripheral devices as well as communication with other components in computing system 108. For example, communication manager 302 may be responsible for generating and maintaining respective communication interfaces between computing system 108 and user mobile device 104.

A processor 304 included in some embodiments of computing system 108 is configured to perform functions that may include generalized processing functions, arithmetic functions, and so on. Processor 304 is configured to process information associated with the systems and methods described herein. Processor 304 may be configured as any combination of microcontrollers, microprocessors, digital signal processors (DSPs), field-programmable gate arrays (FPGAs), graphics processing units (GPUs), accelerated processing units (APUs), central processing units (CPUs), application-specific integrated circuits (ASICs), and so on. Processor 304 may be embodied as a single-core processor, or a multi-core processor. Processor 304 may be implemented as a centralized processor, or in a distributed manner (e.g., a distributed computing system).

Network interface 306 may be used to interface computing system 108 with other computing devices and/or computer networks (e.g., interfacing computing system 108 with network 106). Examples of computer networks include a local area network (LAN), a wide area network (WAN), the Internet, and so on. Network interface 306 may support any combination of wired and wireless connectivity/communication protocols such as Ethernet, Wi-Fi, Bluetooth, ZigBee, etc.

In an aspect, memory 308 includes a non-transitory computer medium. Memory 308 may be comprised of any combination of volatile and non-volatile memory components. Examples of components that may be used to implement memory 308 include random-access memory (RAM), read-only memory (ROM), electrically-erasable programmable read-only memory (EEPROM), flash memory, magnetic memory, optical memory, and so on. Memory 308 may include machine-readable instructions that may be executable by a processor such as processor 304. These machine-readable instructions when executed by the processor 304 cause the processor 304 to perform one or more method steps of an embodiment described herein.

Computing system 108 may include storage 310, that further includes one or more long-term storage devices such as hard disk drives, magnetic drives, magnetic tape, optical storage media (e.g., compact disks (CDs) or digital versatile disks (DVDs)), and so on. Storage 310 may be implemented as a non-transitory computer-readable medium. Storage 310 may be configured to store data and/or instructions related to the operation of computing system 108.

Input/output interface 312 allows other devices or a user to interact with embodiments of the systems described herein. Input/output interface 312 may include any combination of user interface devices such as a keyboard, a mouse, a trackball, one or more visual display monitors, touch screens, incandescent lamps, LED lamps, audio speakers, buzzers, microphones, push buttons, toggle switches, and so on. Input/output interface 312 may alco include interfaces such as USB, Thunderbolt and FireWire that enable computing system 108 to interface with different devices.

Event analysis module 314 may be configured to implement, for example, one or more portions of method 200. Event analysis module 314 may, for example, query media database 102 (206), iterate through the media database 102 (208), and process media metadata batch 120 (210), along with other stages of method 200.

System bus 316 communicatively couples the different components of computing system 108, and allows data and communication messages to be exchanged between these different components.

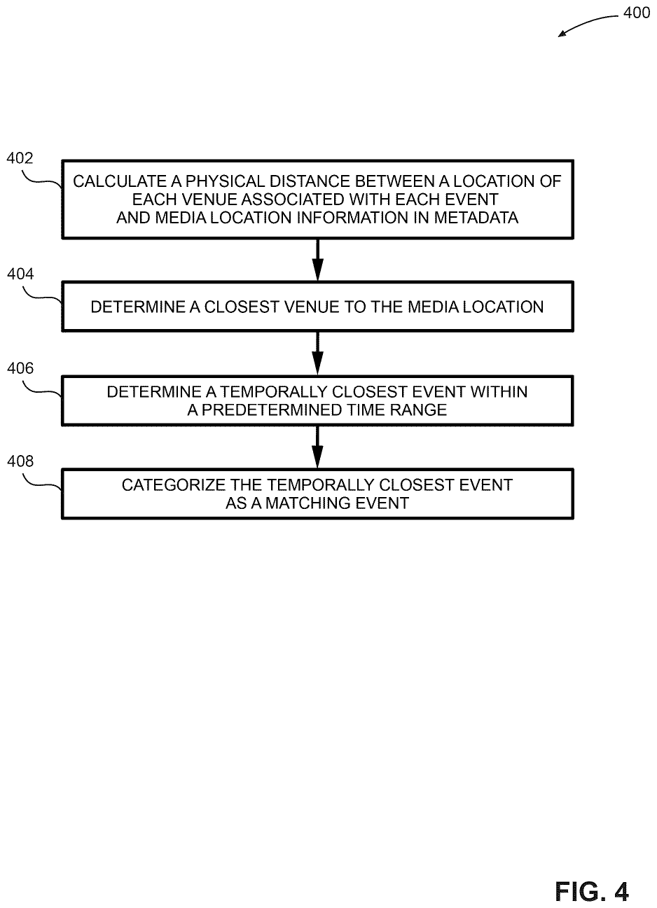

FIG. 4 is a flow diagram depicting a method 400 to categorize a temporally closest event as a matching event. Method 400 may be used to implement stage 212 of method 200.

Method 400 may include calculating a physical distance between a location of each venue associated with each event and media location information in metadata received from user mobile device 104 (402). For example, computing system 108 may calculate, for each venue location stored in venue database 110, a physical distance between the venue location and media location information in media metadata batch 120/122. 402 may be performed for metadata in media metadata batch 120 that is associated with each media file in media database 102.

Method 400 may include determining a closest venue to the media location (404). For example, computing system 108 may determine a closest venue from venue database 110, based on the media location information, for a given (or each) media file.

Method 400 may include determining a temporally closest event within a predetermined time range (406). For example, computing system 108 may determine a temporally closest event to the closest venue from event database 112, for the media file. The temporally closest event may be associated with the closest venue. In one aspect, the temporal closeness is determined based on a predetermined time range (e.g., +/−6 hours from a timestamp associated with the media location information in metadata of the media file as included in media metadata batch 120).

Method 400 may include categorizing the temporally closest event as a matching event (408). For example, computing system 108 may categorize the temporally closest event to the location in the media file metadata as a matching event, and store the matching event information in matched events database 114, as a part of matched events 126.

Other features of event tracking system 100 include:
Remote computing system 108 may be configured to maintain an exhaustive list of ticketed events from a past time period (e.g., 10 years, or 20 years) to match against.
   Coverage may include:
      Sports
      Movies
      Musicals
      Musical/music performances
      Plays
      Concerts, to further include
         All ticketed items from databases such as Vivid
   Remote computing system 108 may be updated daily with new event data
      An initial creation of the list of ticketed items may be based on an initial larger historical ingestion
      New events may be automatically added to the new event list on an ongoing basis
The application software running on user mobile device 104 may upload a complete event history stored on user mobile device 104 to remote computing system 108.
   Remote computing system 108 may be configured to use this event history to serve specific updates about current and/or future events related to future bands and/or sports teams that may be visiting cities near the user (event recommendation)
Remote computing system 108 may be configured to augment the event history with custom information from each event, such as:
   Custom information:
      Set list for concerts
      Box score for events
   Remote computing system 108 uses the event history to create detailed statistics about the user's event history, such as:
      Listening statistics
         Most common songs seen
         Most common cover seen
      Sports statistics
         Win/loss records for favorite team
         For baseball, total homeruns seen
   The event tracking system 100 may be configured to allow the user to share the event history with other users
      The user may be able to upload images and event information to the remote computing system 108 (e.g., a remote server). These images and event information can then be directly shared with other users.

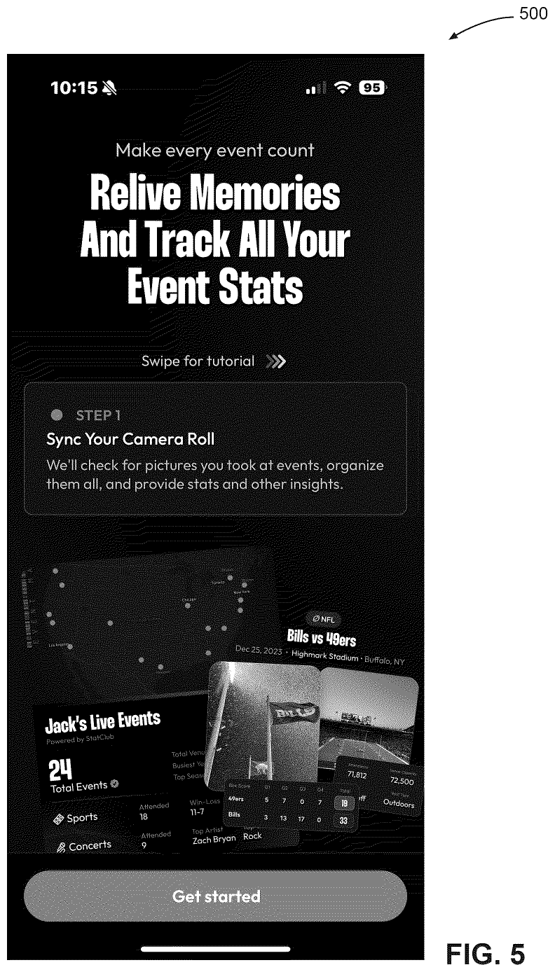

FIGS. 5-17 are screenshots depicting user interfaces associated with the systems and methods described herein. These user interfaces may be presented as graphical user interfaces to a user of user mobile device 104 to enable the user to interact with event tracking system 100. The user interfaces may be interactive, accepting user inputs via touch-sensitive, voice recognition, or other inputs on user mobile device 104.

FIG. 5 is a screenshot 500 depicting a welcome screen interface 500 displayed to the user. As depicted, welcome screen interface 500 displays a welcome message, along with a first step that advises the user to sync their camera roll.

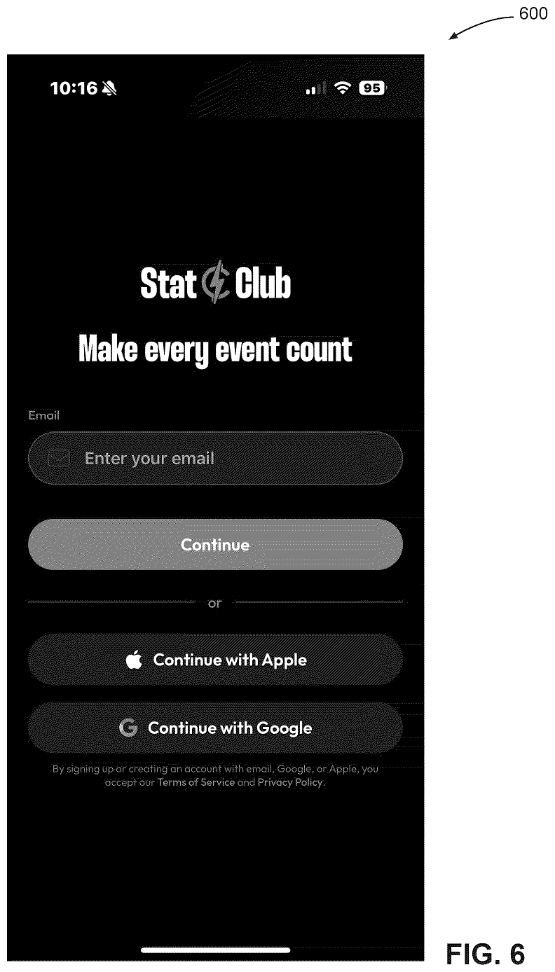

FIG. 6 is a screenshot depicting a user login/registration screen 600 that allows the user to log in to an existing account or create a new user account.

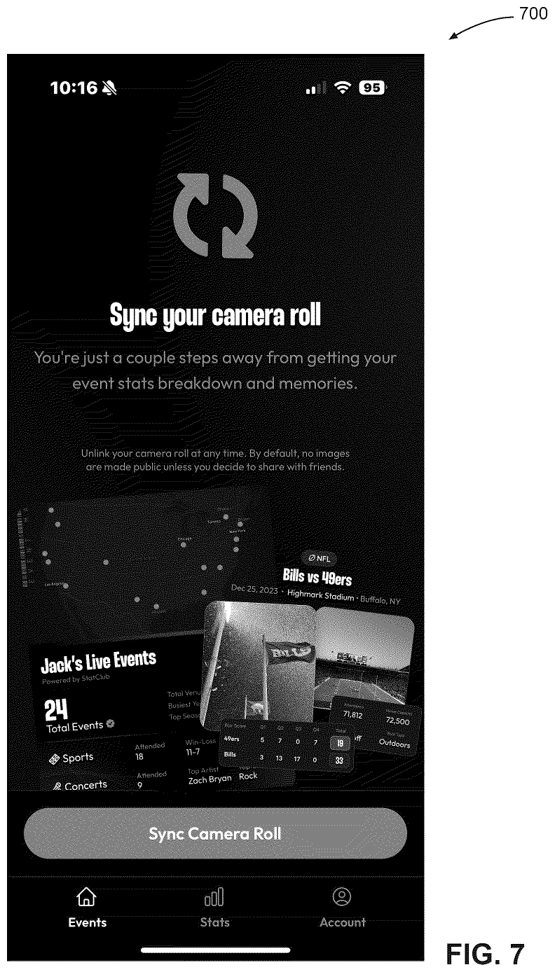

FIG. 7 is a screenshot depicting a user interface 700 post-user login, providing the user an option to sync their camera roll.

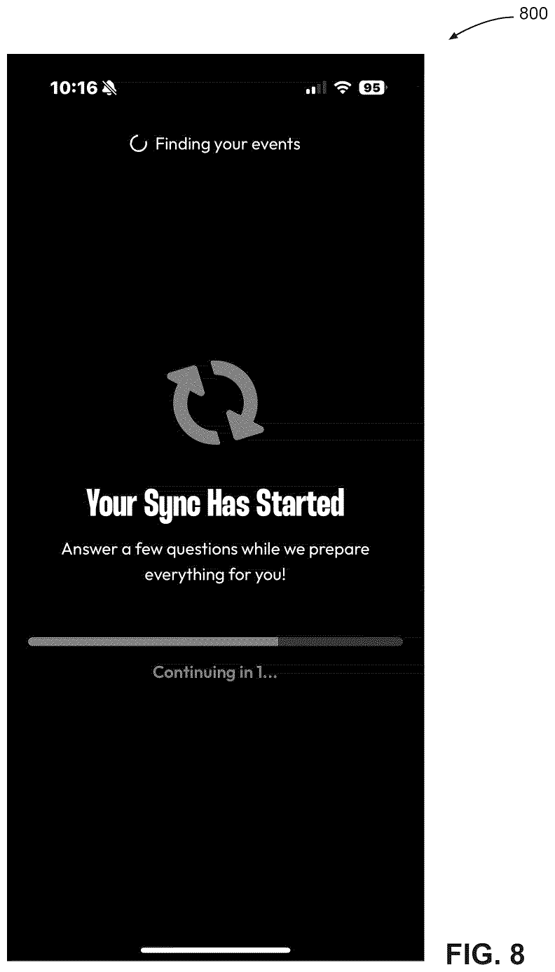

FIG. 8 is a screenshot depicting an interface 800 showing a sync in process. If the user selects the option to sync their camera roll on the interface 700, the user interface presents interface 800 that displays a progress of the sync. Interface 800 may advise the user to answer one or more questions while the sync in process. The user-provided answers are used to provide an enhanced user experience.

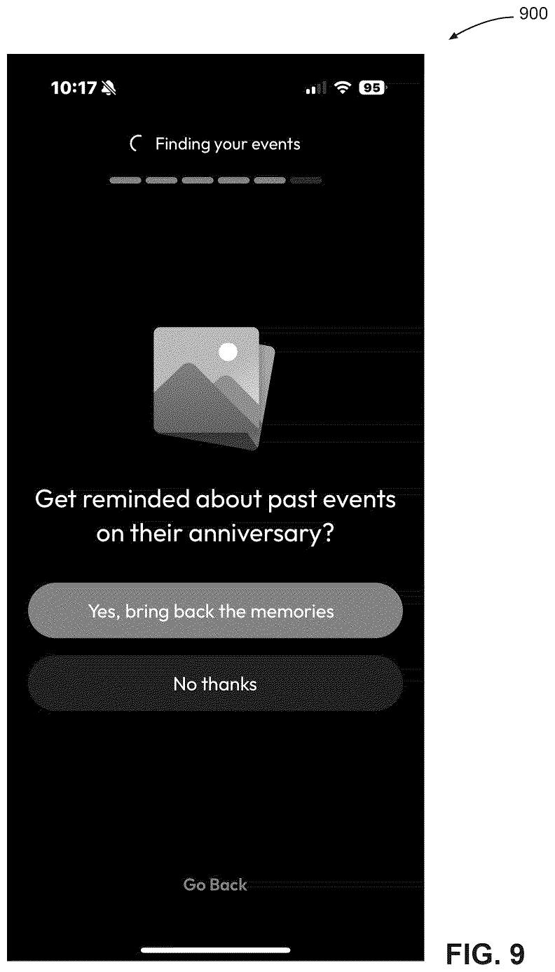

FIG. 9 is a screenshot depicting a user interface 900 that presents a question of the one or more questions for the user.

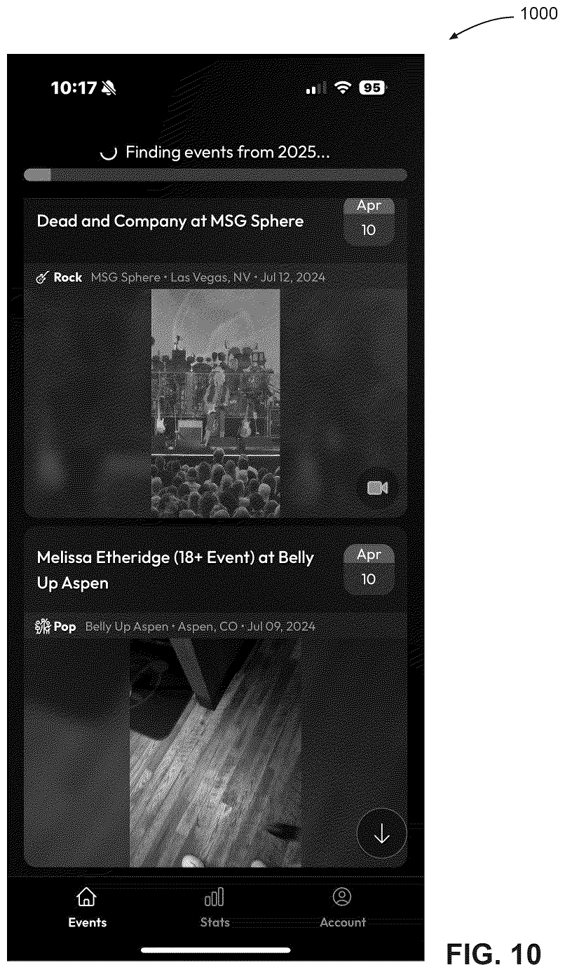

FIG. 10 is a screenshot depicting a user interface 1000 that presents one or more events (media and textual information) to the user from a specific year (in this case, 2025). User interface 1000 also depicts the event tracking system 100 finding events from 2025 (e.g., processing media metadata batch 120).

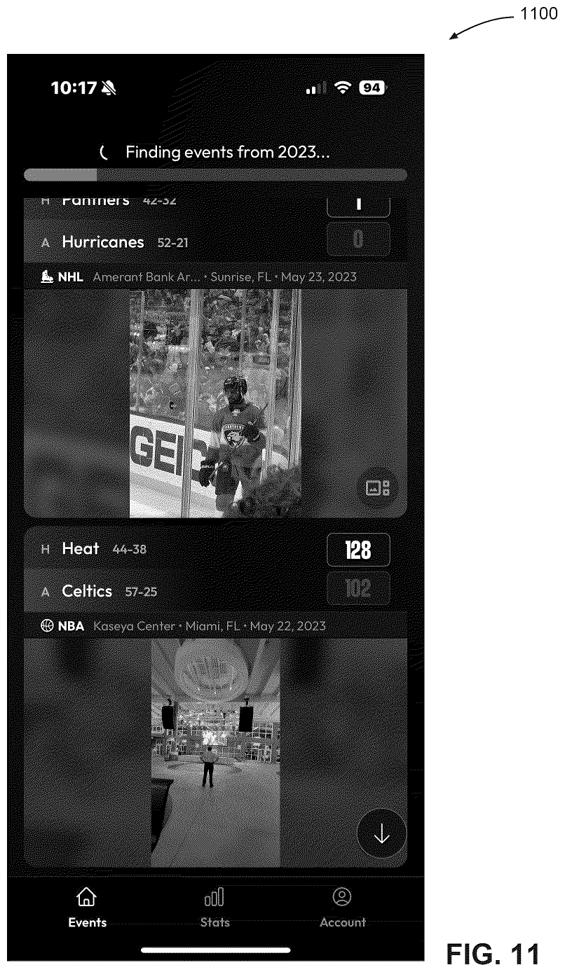

FIG. 11 is a screenshot depicting a user interface 1100 that presents one or more events (media and textual information) to the user from a specific year (in this case, 2023). User interface 1100 also depicts the event tracking system 100 finding events from 2023 (e.g., processing media metadata batch 120).

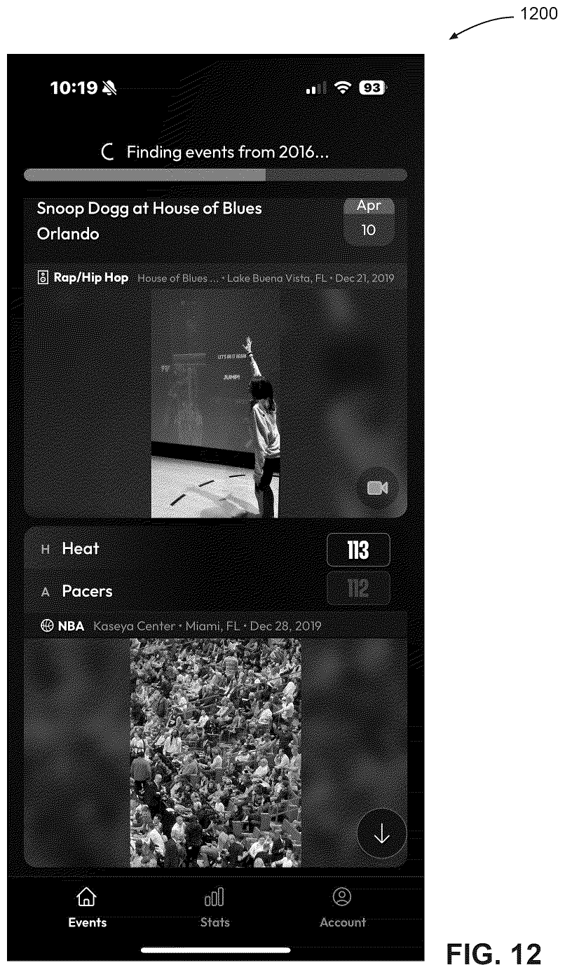

FIG. 12 is a screenshot depicting a user interface 1200 that presents one or more events (media and textual information) to the user from a specific year (in this case, 2016). User interface 1200 also depicts the event tracking system 100 finding events from 2016 (e.g., processing media metadata batch 120).

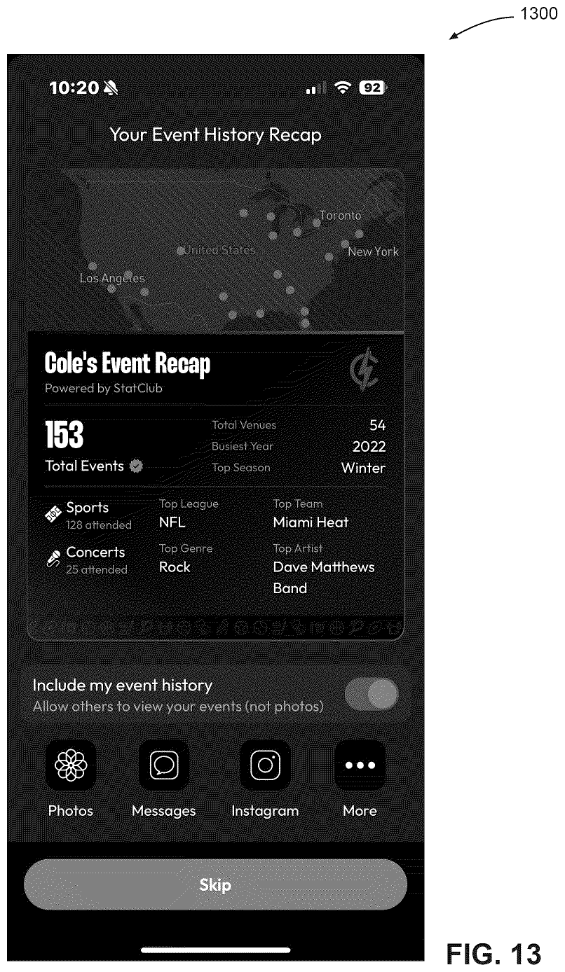

FIG. 13 is a screenshot depicting a user interface 1300 that provides a summary of the user's event history. User interface 1300 may include insights and statistics. For example, the event history may include a total number of events attended, a total number of venues attended, a busiest year, a top season, and other categories as shown in user interface 1300. The user may also have an option to allow other users to view the matched events.

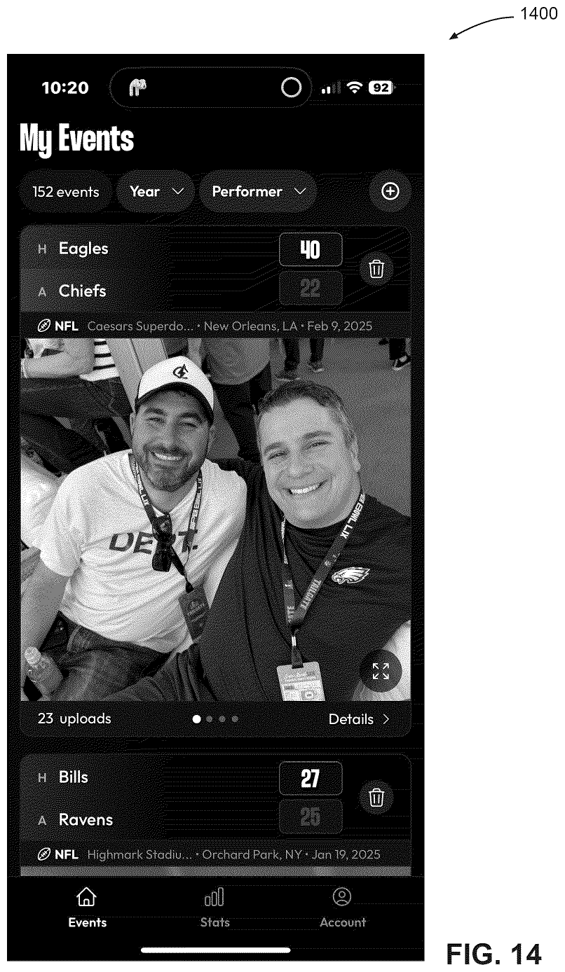

FIG. 14 is a screenshot depicting a user interface 1400 that provides an overview of the user's events. In FIG. 14, the user interface 1400 presents sports events, along with one or more images captured at those events.

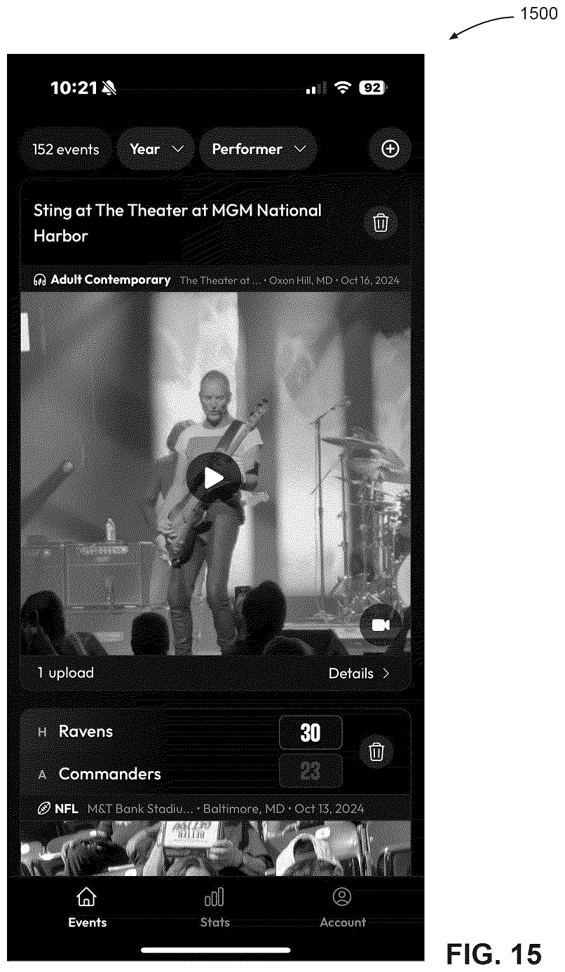

FIG. 15 is a screenshot depicting a user interface 1500 that provides an overview of the user's events. In FIG. 15, the user interface 1500 presents music and sports events, along with one or more images captured at those events.

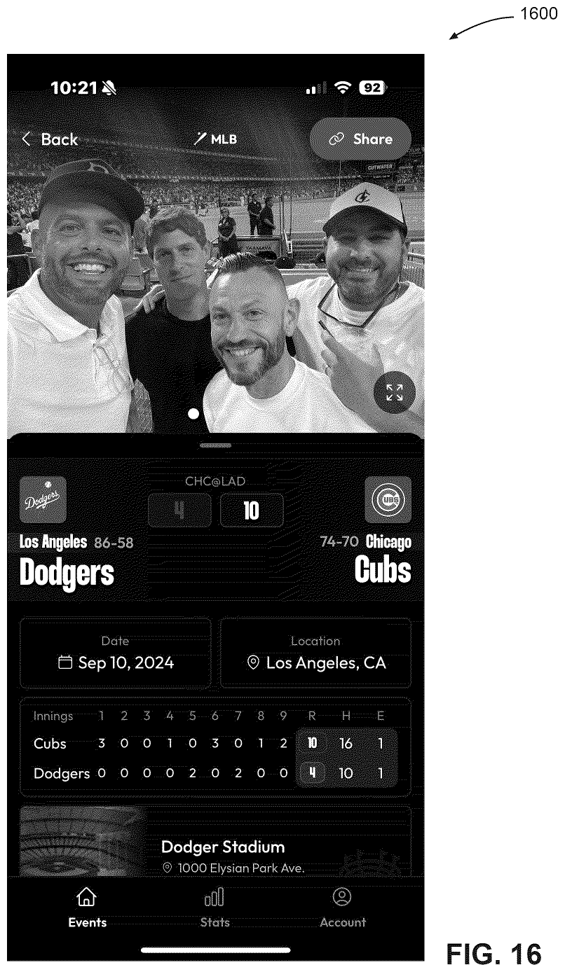

FIG. 16 is a screenshot depicting a user interface 1600 that provides an overview of the user's events. In FIG. 16, the user interface 1600 presents a sporting event, along with one or more images captured at that event.

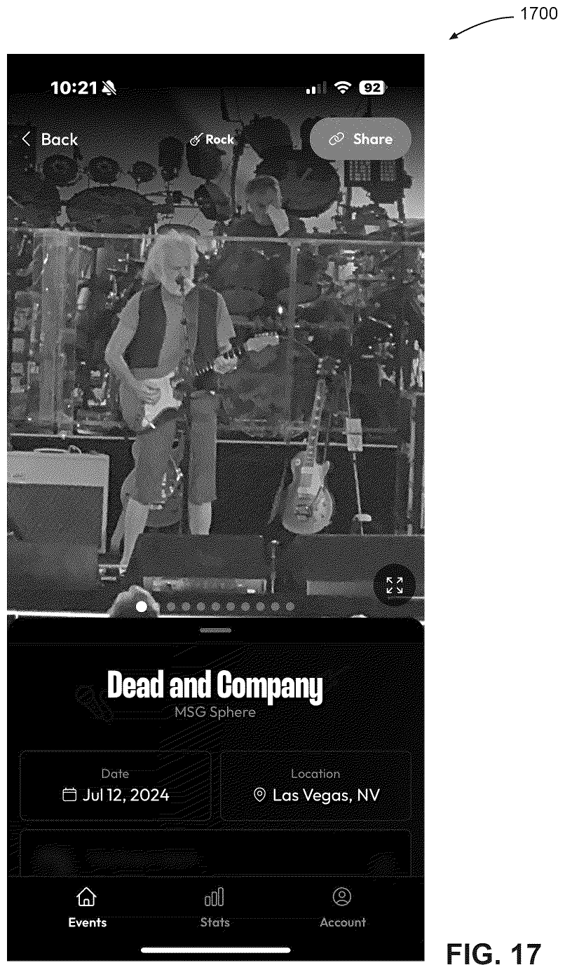

FIG. 17 is a screenshot depicting a user interface 1700 that provides an overview of the user's events. In FIG. 17, the user interface 1700 presents a musical event, along with one or more images captured at that event.

In an aspect, the user interfaces 1400 through 1700 may be linked via continuous scrolling operations. For example, starting at user interface 1400, a user may be able to scroll (e.g., by swiping or by using other touchscreen-related gestures), through user interfaces 1500, 1600, 1700 and beyond, if additional events are available.

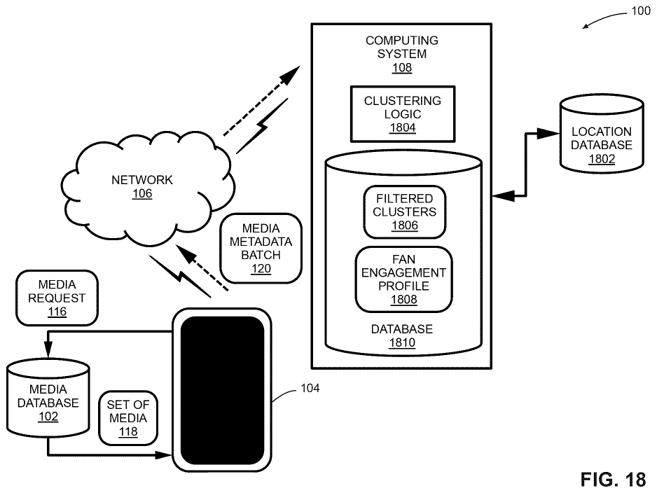

FIG. 18 is a block diagram depicting a computer architecture of a fan profile generation system 1800. As depicted, fan profile generation system 1800 includes media database 102, user mobile device 104, network 106, remote computing system 108, and location database 1802. Remote computing system 108 further includes clustering logic 1804 and database 1810.

In an aspect, user mobile device 104 is configured to communicate with remote computing system 108 via network 106. Network 106 may be a public network (e.g., the Internet), or a private network. User mobile device 104 may be carried by a user to different locations (e.g., restaurants, shops, gyms, events such as movies and sporting events, etc.). The user may use user mobile device 104 to capture media and generate media files comprising one or more images and/or video when the user is at a specific location. This media may be stored to media database 102, included in the user mobile device 104. Alternatively, media database 102 may be a database on a remote server such as a cloud server.

In one aspect, user mobile device 104 is a portable/mobile computing system/platform such as a mobile phone, a tablet, a laptop computer, and so on. The systems and methods described herein can also be implemented using a user computing device such as a desktop computer (not depicted in FIG. 18) that may be used in conjunction with or in place of user mobile device 104. As will be generally understood, the user mobile device 104 is a user computing system that includes at least one processor, a memory, and a network interface.

In an aspect, the media stored on media database 102 may also include embedded data/metadata related to exposure information, date and time, media capture device information, and GPS-enabled location. In an aspect, remote computing system 108 may be implemented as a remote server (e.g., a cloud-based computing system or a cloud-based server). Remote computing system 108 may communicate with user mobile device 104 and the user via, for example, an application software (app) running on user mobile device 104. The application software running on user mobile device 104 may be configured to communicate with computing system 108 via network 106.

In one aspect, user mobile device 104 periodically initiates a media request 116 to media database 102 (e.g., when the user opens the app running on user mobile device 104). Media database 102 (e.g., a camera roll) may respond with an output that includes a complete set of media 118 (e.g., an entire camera roll). User mobile device 104 may extract metadata from each media file from the media database 102. In an aspect, user mobile device 104 creates one or more media metadata batches from all the metadata, and transmits the metadata batches 120 to remote computing system 108, via network 106. Clustering logic 1804 included in remote computing system 108 may process the metadata and create one or more clusters of similar locations from the metadata as a part of a synchronization process.

In an aspect, once all clusters have been formed, each cluster is associated with a specific location from location database 1802, which is configured to store a set of different kinds of locations, as described herein. A filtering process implemented by remote computing system 108 may be used to filter out any clusters that are less than a certain threshold size, to generate filtered clusters 1806. In an aspect, the threshold size of a cluster is a number of locations in the respective cluster. For each filtered cluster, a time range may be created by remote computing system 108.

In an aspect, all filtered clusters 1806 and their associated locations remaining are categorized and aggregated by remote computing system 108, and then stored in database 1810. All filtered clusters 1806 are then analyzed, and their associated classifications are used to infer demographic traits by remote computing system 108. In response to this inference, a fan engagement profile 1808 may be generated by remote computing system 108. Fan engagement profile 1808 may be stored in database 1810.

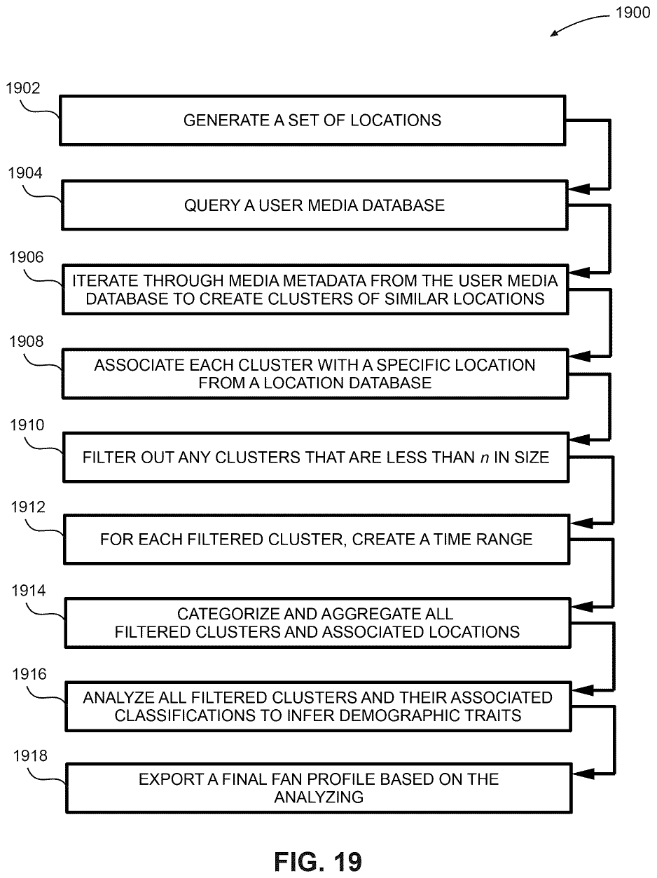

FIG. 19 is a flow diagram depicting a method 1900 to generate a fan profile. Method 1900 may be implemented by remote computing system 108. Method 1900 may include generating a set of locations (1902). This set of locations may be stored in location database 1902, and may include locations that may be visited by the user. Each location may be labeled with any combination of one or more NAICS codes, European NACE codes, or some other kind of code. Examples of such locations include but are not limited to restaurants, gyms, arenas, movie theaters, playhouses, hotels, other entertainment locations such as clubs and arcades, education locations such as universities and community colleges, and transportation locations such as airports and train stations. Location database 1802 may be populated by using existing available data (e.g., commercially-available GPS and location data).

Method 1900 may include querying a user media database (1904). For example, user mobile device 104 may initiate media request 116 to media database 102, to retrieve set of media 118. User mobile device 104 may transmit media metadata batch 120 via network 106 to remote computing system 108, as described above.

Method 1900 may include iterating the media metadata from the user media database to create clusters of similar locations (1906). For example, remote computing system 108 (specifically, clustering logic 1804) may iterate through the media metadata 120 to create clusters of similar locations at which one or more media files have been captured. In an aspect, a radius r associated with a distance of each cluster from a specific location may be adjusted to any size. For example:
If a location associated with a media file exists within r of any other media file location in the cluster, the first location will be included in that cluster.
If a cluster interacts with any other cluster, those clusters are merged together.

Method 1900 may include associating each cluster with a specific location from a location database (1908). For example, remote computing system 108 (e.g., clustering logic 1804) may associate each cluster with a specific location from location database 1802. In one aspect, 1908 includes:
Creating a cluster center point for each cluster by averaging a latitude and a longitude associated with a capture location of each media file, as indicated in media metadata 120.
The associated location will be the location from location database 1802 that is closest to the center point. In an aspect, a measure of closeness is used to calculate the location closest to the center point. The measure of closeness may be a Euclidean distance from the center point of a location from location database 1802 to the center point of the cluster.

Method 1900 may include filtering out any clusters that are less than n in size (1910). For example, clustering logic 1804 may perform this filtering process to generate filtered clusters 1806 which may be stored on database 1810. In an aspect, after a user's location clusters have been formed, any clusters that are less than n in size are filtered out, where n is a selected threshold value, and a size of a cluster is measured by a number of locations included in the cluster, where the locations are associated with media files from media database 102. In an aspect, the threshold size n can be adjusted to change a granularity of the analysis (e.g., the filtering process).

Method 1900 may include creating a time range for each filtered cluster (e.g., in filtered clusters 1806) (1912). In an aspect, creating a time range is performed by remote computing system 108, and includes:
Ordering the clustered locations from earliest to latest in terms of intraday time (ignoring the calendar date).
Filtering out the first p percentile locations and the final p percentile locations, where p is a selected threshold. This gives the middle 100-2p range.
The outer bounds of this middle range become the time range.
Classifying the time range into categories (e.g., morning, afternoon, night, late-night, and a duration in hours).

Method 1900 may include categorizing and aggregating all filtered clusters and associated locations (1914). In an embodiment, the categorizing and aggregating is performed by remote computing system 108, on filtered clusters 1806. In an aspect, each location the following classifications:
a) Classifications
   i) Category—the higher-level classification of the location.
   ii) Subcategory—the more granular classification of the location.
   iii) Name—the name of the specific store or brand.
   iv) Price Category—the price category of the location (relative to other locations in the category).
b) All filtered clusters are iterated through and all classifications are aggregated. In an aspect, aggregation can be cut by time of day and/or by location for different analyses (e.g., morning in New York).

Method 1900 may include analyzing all filtered clusters 1806 and their associated classifications to infer demographic traits (1916). For example, remote computing system 108 may analyze filtered clusters 1806 and:
Estimate an income bracket by evaluating a plurality of parameters, such as averaging a price category of all visited locations, weighted by visit frequency and recency, averaging within each venue category (hotels, restaurants, etc.) and then averaging across those venue categories, and looking for examples of high-price places that may be frequented but are still a small percentage of total venues visited.
Identify lifestyle traits by finding dominant categories and subcategories (e.g., frequent visits to gyms, coffee shops, or luxury retail).
Generate behavioral tags (e.g., “nightlife”, “frequent traveler”) using time-of-day patterns, location types, and cluster frequency.

Method 1900 may include exporting a final fan profile based on the analyzing (1918). For example, remote computing system 108 may generate a final fan profile (i.e., fan engagement profile 1808) stored on database 1810.

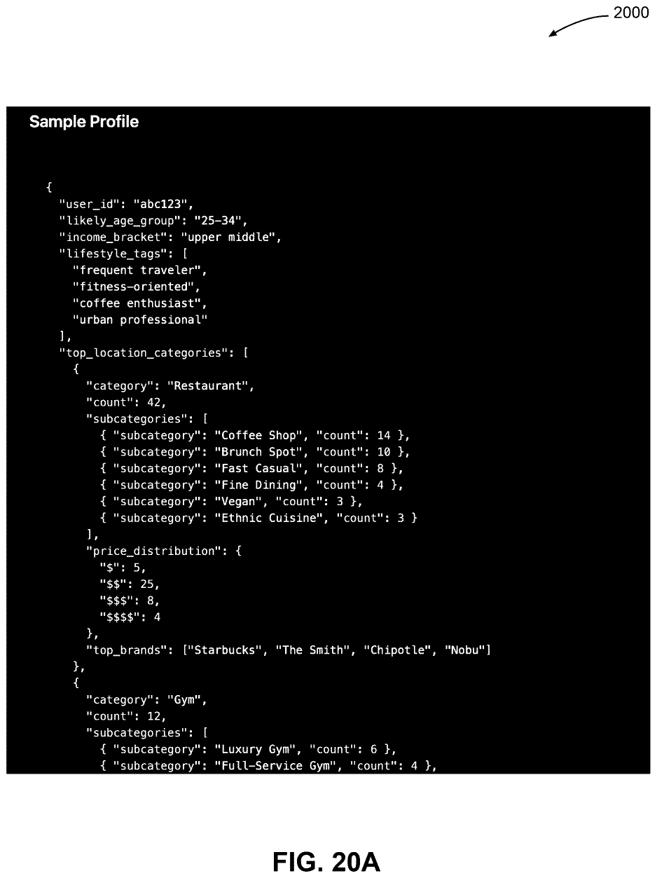

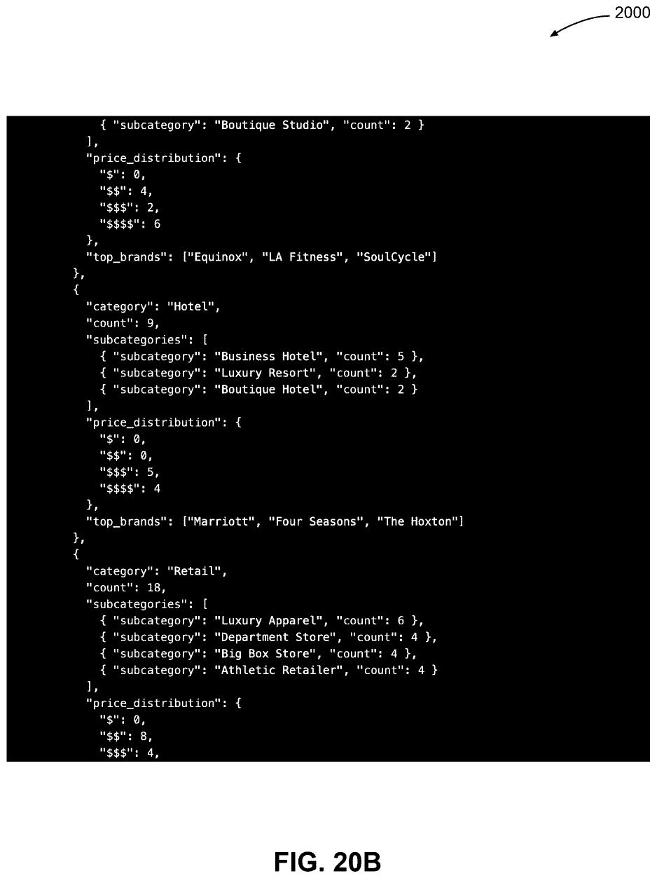

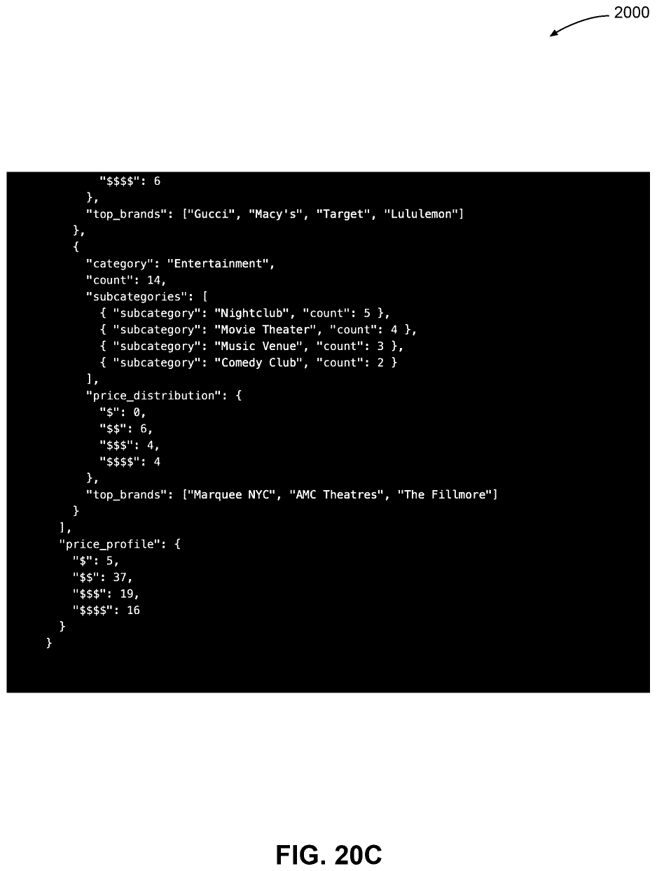

FIGS. 20A-20C are screenshots depicting a sample fan profile 2000. As seen in these figures, each user is associated with a user ID, and the systems and methods described herein make predictions about the profile of the user (e.g., likely age, income bracket, lifestyle characteristics, etc.). The tables below provide classification examples and price categories.

TABLE 1
Classification Examples

| Category | Subcategory | Name | Price Category |
|---|---|---|---|
| Restaurant | Fast Casual | Chipotle | $$ |
| Restaurant | Fine Dining | Nobu | $$$$ |
| Restaurant | Coffee Shop | Starbucks | $$ |
| Restaurant | Casual Dining | Olive garden | $$ |
| Restaurant | Fast Food | McDonald's | $ |
| Restaurant | Brunch Spot | The Smith | $$$ |
| Restaurant | Vegan | By Chloe | $$ |
| Restaurant | Steakhouse | Peter Luger | $$$$ |
| Restaurant | Ethnic Cuisine | Xi'an Famous Foods | $$ |
| Retail | Grocery Store | Whole Foods Market | $$$ |
| Retail | Discount Store | Dollar Tree | $ |
| Retail | Luxury Apparel | Gucci | $$$$ |
| Retail | Department Store | Macy's | $$ |
| Retail | Big Box Store | Target | $$ |
| Retail | Athletic Retailer | Lululemon | $$$ |
| Hotel | Business Hotel | Marriott | $$$ |
| Hotel | Budget Hotel | Motel 6 | $ |
| Hotel | Luxury Resort | Four Seasons | $$$$ |
| Hotel | Boutique Hotel | The Hoxton | $$$ |
| Hotel | Extended Stay | Residence Inn | $$ |
| Gym | Boutique Studio | SoulCycle | $$$ |
| Gym | Full-Service Gym | LA Fitness | $$ |
| Gym | Luxury Gym | Equinox | $$$$ |
| Gym | Budget Gym | Planet Fitness | $ |
| Entertainment | Nightclub | Marquee NYC | $$$$ |
| Entertainment | Movie Theater | AMC Theaters | $$ |
| Entertainment | Bowling Alley | Bowlero | $$ |
| Entertainment | Music Venue | The Fillmore | $$ |
| Entertainment | Comedy Club | The Comedy Cellar | $$$ |
| Entertainment | Arcade Bar | Barcade | $$ |
| Education | University Campus | NYU | N/A |
| Education | K-12 School | PS 321 | N/A |
| Education | Community College | Santa Monica College | N/A |
| Transportation | Airport | LAX | N/A |
| Transportation | Train Station | Grand Central | N/A |
| Transportation | Rideshare Hub | Uber Greenlight Hub | N/A |

TABLE 2
Price Categories

| Symbol | Description |
|---|---|
| $ | Budget |
| $$ | Affordable/Mid |
| $$$ | Upscale |
| $$$$ | Luxury/Premium |
| N/A | Not price relevant |

In one aspect, instead of determining/detecting an event within a certain timeframe, the system may identify a restaurant that has been visited by the user. To do this, the media metadata in media metadata batch 120 is analyzed to extract geolocation information (e.g., GPS information) associated with a location of the restaurant. Based on the geolocation information, computing system 108 may access location database 1802 and determine that metadata associated with an image captured by the user is at a time when the user was at a specific restaurant. A restaurant list may be initialized and updated for this user. This list may include the following information for each restaurant:
Restaurant name,
Type of the restaurant (e.g., fine dining, fast food, etc.),
Price profile associated with the restaurant (e.g., budget, affordable/mid, upscale, luxury/premium, etc.),
Type (or types) of cuisine served (e.g., American, Italian, French, Chinese, Japanese, British, etc.),
Visit frequency by the user (e.g., number of times per week or per month the restaurant is visited by the user),
Dining times (e.g., morning, afternoon, evening, late night).
Neighborhood information associated with the restaurant (e.g., shopping, fitness centers, other dining locations, etc.).

Based on the restaurant list, a restaurant profile/dining profile may be generated for the user that includes and provides insights into the user's dining habits and preferences.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method comprising:
querying a user media database;
receiving metadata associated with user media stored in the user media database based on the querying;
analyzing the metadata to determine one or more locations that have been visited by a user associated with the user media;
determining a match between location information in the metadata and a restaurant location included in the one or more locations;
adding the restaurant location to a list of restaurant locations visited by the user; and
generating a dining profile for the user based on the list.

2. The method of claim 1, wherein analyzing the media metadata includes analyzing GPS information included in the metadata to extract geolocation information.

3. The method of claim 1, wherein for each restaurant included in the list, the list includes any combination of a restaurant name, a type of the restaurant, a price profile associated with the restaurant, a type or types of cuisine served by the restaurant, a visit frequency by the user, one or more dining times, and neighborhood information associated with the restaurant.

4. The method of claim 3, wherein the price profile is associated with any of budget, affordable/mid, upscale, and luxury/premium labels.

5. The method of claim 3, wherein the visit frequency is any of a number of times a week or a number of times a month that the user dines at the restaurant.

6. The method of claim 3, wherein the dining times are any combination of morning, afternoon, evening, and late night.

7. The method of claim 3, wherein the neighborhood information includes information about one or more shopping facilities, other dining facilities, and fitness centers in a neighborhood associated with the restaurant.

8. The method of claim 1, wherein the user media includes any combination of still image files and video files.

9. The method of claim 1, wherein the restaurant profile is used to generate a dining profile for the user.

10. The method of claim 1, wherein each restaurant is identified by any combination of a North American Industry Classification System (NAICS) code and a European NACE code.

11. A system comprising:
a user mobile device including an image capturing device, the image capturing device configured to capture one or more media files and store the media files to a user media database associated with the user mobile device;
a location database configured to store a set of locations; and
a computing system communicatively coupled to the user mobile device and to the location database, the computing system configured to:
query the user media database;
receive metadata associated with the media files based on the query;
analyze the metadata to determine one or more locations included in the location database that have been visited by a user associated with the user media;
determine a match between location information in the metadata and a restaurant location included in the one or more locations;
add the restaurant location to a list of restaurant locations visited by the user; and
generate a dining profile for the user based on the list.

12. The system of claim 11, wherein analyzing the media metadata includes analyzing GPS information included in the metadata to extract geolocation information.

13. The system of claim 11, wherein for each restaurant included in the list, the list includes any combination of a restaurant name, a type of the restaurant, a price profile associated with the restaurant, a type or types of cuisine served by the restaurant, a visit frequency by the user, one or more dining times, and neighborhood information associated with the restaurant.

14. The system of claim 13, wherein the price profile is associated with any of budget, affordable/mid, upscale, and luxury/premium labels.

15. The system of claim 13, wherein the visit frequency is any of a number of times a week or a number of times a month that the user dines at the restaurant.

16. The system of claim 13, wherein the dining times are any combination of morning, afternoon, evening, and late night.

17. The system of claim 13, wherein the neighborhood information includes information about one or more shopping facilities, other dining facilities, and fitness centers in a neighborhood associated with the restaurant.

18. The system of claim 11, wherein the user media includes any combination of still image files and video files.

19. The system of claim 11, wherein the restaurant profile is used to generate a dining profile for the user.

20. The system of claim 11, wherein each restaurant is identified by any combination of a North American Industry Classification System (NAICS) code and a European NACE code.
